(19) United States
(12) Patent Application Publication
(10) Pub. No.: US 2006/0244414 A1
(43) Pub. Date: Nov. 2, 2006

(54) Device for electrical power supply to a power tool

(76) Inventor: David Lay, West Highland, UT (US)

Correspondence Address: STRIKER, STRIKER & STENBY, 103 EAST NECK ROAD, HUNTINGTON, NY, 11743, US

(21) Appl. No.: 11/143,898

(22) Filed: Jun. 2, 2005

Related U.S. Application Data
(60) Provisional application No. 60/676,593, filed on Apr. 29, 2005.

(51) Int. Cl. H02J 7/00

(52) U.S. Cl. 320/107

(57) ABSTRACT

A device for electrical power supply to an electrically powered tool has a belt adapted to be worn by a user, a plurality of batteries arranged on the belt and electrically connected with one another, an electric cable having a first end connected with the batteries, extending outwardly beyond the belt, and having a second opposite end, and an additional battery connected with said second end of said electric cable and connectable to a power tool so as to supply the power tool with electrical power from the batteries or to a battery charger for charging the batteries.

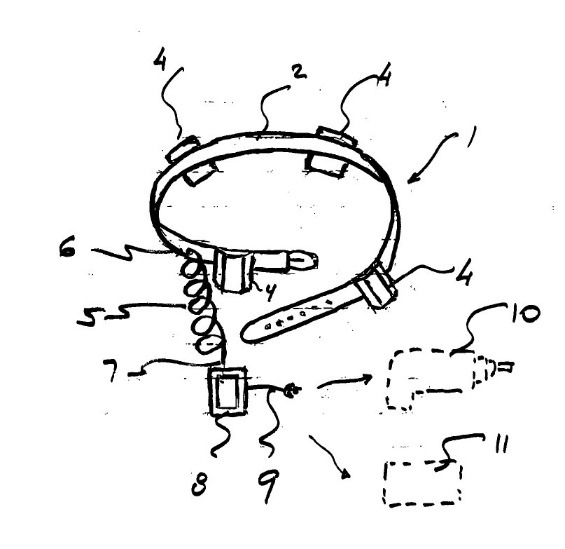

### BACKGROUND OF THE INVENTION

The present invention relates to a device for electrical power supply to a power tool.

Devices for supplying electrical power to power tools which include articles of clothing such as belts are known in the art. U.S. Pat. No. 4,667,362 discloses a device of this type which has a holster for storing a tool with contacts connectable to batteries for recharging, and a base which engages the holster and makes electrical contact with the contacts on the tool through openings in the holster. In this device the batteries are not supported on or connected with the holster.

U.S. Pat. No. 4,827,534 discloses a sun-powered vest. The vest has a plurality of photovoltaic cells mounted on a back panel and connected with one another for charging rechargeable batteries or connectable to an input jack of a power tool having a rechargeable battery. The rechargeable batteries are arranged in carrying cases clipped on the belt or suspended therefrom.

U.S. Pat. No. D333,215 discloses a tool pouch with a holster for a cordless drill. The tool pouch has a compartment for accommodating the cordless drill. It does not disclose the arrangement of the electrical power batteries.

U.S. Pat. No. 5,211,321 discloses a battery and an equipment vest in which a plurality of compartments are provided for accommodating batteries and a charger. They are arranged directly on the vest.

U.S. Pat. No. 5,929,597 discloses a portable electric power system with a battery pack attached to a vest, and an adaptor connected through a cord to the battery pack and connectable to an electrical device such as for example a power drill. All batteries are provided directly on the vest.

U.S. Pat. No. 5,680,026 discloses a tool belt with a battery assembly. In this device a plurality of batteries are arranged on the belt, and a cable extends from the belt to a recharger for recharging the batteries.

U.S. Pat. Nos. 6,007,940 and 6,106,971 disclose a device including an electric power tool, a low rate battery pack which is remote from the tool, and a cable interconnecting the pack to the tool. In one embodiment of the invention all batteries are mounted directly on the belt, while in another embodiment all batteries are arranged on the vest fora user.

U.S. patent application No. 2001/0035736 discloses a tool storage apparatus which has a pouch with pockets for the drill and for the battery pack, wherein the drill is attachable to the battery pack through a cord.

U.S. Pat. No. 6,260,978 discloses a battery power and light belt, with battery holders provided on the belt and connected with one another, and with a light device for illumination.

U.S. Pat. No. 6,501,197 discloses a power tool provided with a remote battery pack with batteries arranged on the battery belt and connected with one another and to a tool through a cable.

Finally, U.S. Pat. No. 6,556,843 discloses a power source unit for an electrical power tool with a battery pack chargeable through an adaptor.

It is believed that the existing devices of this type can be further improved.

### SUMMARY OF THE INVENTION

Accordingly, it is an object of the present invention to provide a device for electrical power supply to a power tool, which is a further improvement of the existing devices.

In keeping with these objects and with others which will become apparent hereinafter, one feature of the present invention resides, briefly stated, in a device for electrical power supply to an electrically powered tool, comprising a belt adapted to be worn by a user; a plurality of batteries arranged on said belt and electrically connected with one another; an electric cable having a first end connected with said batteries, extending outwardly beyond said belt, and having a second opposite end; and an additional battery connected wtih said second end of said electric cable and connectable to a power tool so as to supply said power tool with electrical power from said batteries or to a battery charger for charging said batteries.

When the device for electrical power supply to a power tool is designed in accordance with the present invention, it is compact, convenient to use, and simple to connect to an electrically powered tool for its operation and to a charging device for charging the batteries.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings is a perspective view showing a device for electrical power supply to a power tool in accordance with the present invention.

### DESCRIPTION OF THE PREFERRED EMBODIMENTS

A device for electrical power supply to an electrically powered tool has an article of clothing which is identified as a whole with reference numeral 1. The article of clothing is formed as a belt 2 which can be worn by a user. The belt for this purpose has buckle means 3 which are closeable and openable, so as to close the belt while on a user to be worn, and to open the belt when it is necessary to remove the device from the user. The buckle means can be formed in any conventional way.

The device for electrical power supply to a power tool further has a plurality of batteries which are identified with reference numeral 4. The batteries 4 are arranged on the belt 2 at certain distances from one another. The batteries 4 can be permanently attached to the belt, they also can be removably attached to the belt, they also can be stored in special pockets provided on the belt, etc. The batteries 4 are connected with one another by electrical connecting means which are known per se, so as to form a battery pack.

The device for electrical power supply to a power tool in accordance with the present invention further has an electric cable which is identified with reference numeral 5. The electric cable 5 has a first end 6 which is connected with the electrical connecting means that connects all electrical batteries 4 with one another, or with at least one of the batteries 4. The electric cable 5 extends outwardly beyond the article of clothing, in particular outwardly beyond the belt 2, and has a second opposite end 7.

A device for electrical power supply to a power tool further has an additional battery 8 which is connected with the second end 7 of the electric cable 5. The additional battery 8 is also located outside of and remote from the article of clothing or the belt 2. The additional battery 8 is provided with electrical connecting means which are identified as whole with reference numeral 9. The electrical connecting means 9 is formed so as to connect the additional battery 8 either to an electrically powered tool or to a charging device. The electrical connecting means 9 can be formed, for example, as an electric cable extending from the additional battery 8.

In order to operate the electrically powered tool identified with reference numeral 10, the article of clothing in particular the belt 2 is placed on a user, and the cable 9 is connected to the power tool so as to supply electrical power energy from the batteries 4 and 8 to the power tool 10. When the batteries have to be recharged, the cable 9 is connected to an electrical charging source 11 which can be an electrical charger, an electrical power grid, etc.

It will be understood that each of the elements described above, or two or more together, may also find a useful application in other types of constructions differing from the types described above.

While the invention has been illustrated and described as embodied in a device for electrical power supply to a power tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A device for electrical power supply to an electrically powered tool, comprising a belt adapted to be worn by a user; a plurality of batteries arranged on said belt and electrically connected with one another; an electric cable having a first end connected with said batteries, extending outwardly beyond said belt, and having a second opposite end; and an additional battery connected with said second end of said electric cable and connectable to a power tool so as to supply said power tool with electrical power from said batteries or to a battery charger for charging said batteries.

2. A device as defined in claim 1; and further comprising means for alternatingly electrically connecting said additional battery with the power tool or with the battery charger.

3. A device as defined in claim 2, wherein said alternatingly electrically connecting means includes an electric cable.

4. A device as defined in claim 1, wherein said first-mentioned batteries are distributed along said belt and spaced from one another.
